(19) United States
(12) Patent Application Publication
(10) Pub. No.: US 2018/0121658 A1
(43) Pub. Date: May 3, 2018

(54) CYBER RISK ASSESSMENT AND MANAGEMENT SYSTEM AND METHOD

(71) Applicant: Gemini Cyber, Inc., North Charleston, SC (US)

(72) Inventors: Douglas Marshall Ross, Mount Pleasant, SC (US); Christopher Edwards, North Charleston, SC (US)

(21) Appl. No.: 15/794,313

(22) Filed: Oct. 26, 2017

Related U.S. Application Data
(60) Provisional application No. 62/413,839, filed on Oct. 27, 2016.

(51) Int. Cl. G06F 21/57; G06F 17/10

(52) U.S. Cl. CPC G06F 21/577; G06F 17/10

(57) ABSTRACT

A system for cyber risk assessment includes: a processor; and memory connected to the processor, wherein the memory stores instructions that, when executed by the processor, cause the processor to: receive data corresponding to one or more technology stacks; access one or more security standards in a data store connected to the processor, at least one of the security standards corresponding to at least one of the technology stacks; and determine a cyber risk score based on the data and the at least one of the security standards.

### CROSS-REFERENCE TO RELATED APPLICATION

This application claims priority to, and the benefit of, U.S. Provisional Application No. 62/413,839, filed on Oct. 27, 2016, the content of which is incorporated herein by reference in its entirety.

### BACKGROUND

### 1. Field of the Invention

One or more aspects of example embodiments of the present invention relate generally to cyber security analysis, and more specifically, to systems and methods that provide a cyber risk assessment which may assist in underwriting cyber insurance policies.

### 2. Description of the Related Art

With the advent of the Internet and the proliferation of computers and computer-related products, organizations have become more dependent on networked computer assets, making them more vulnerable to harm from increasing attacks that result in critical data and financial losses. Traditional business insurance policies typically do not cover new computer related risks, in part because of the difficulty in underwriting these threats.

Cyber insurance is a specialty insurance product that covers losses associated with a company's information assets including computer generated, stored, and processed information. However, due to the ever-changing nature of cyber security and cyber vulnerabilities, as well as constant information and product updates, traditional insurance or even cyber insurance policies and associated underwriting royalties may not adequately correspond to the level of associated risk. Furthermore, given the novelty, relatively limited general knowledge of the importance of cyber insurance, and reduced objectivity and clarity in current cyber risk assessment methods and underwriting, commercializing current cyber insurance products may be difficult.

Therefore, there is a need for assessing and weighting vulnerabilities in a manner that allows underwriting to occur in an automatic, real-time way, while increasing risk assessment objectivity and clarity and decreasing commercialization difficulties.

The above information disclosed in this Background section is for enhancement of understanding of the background of the invention, and therefore, it may contain information that does not constitute prior art.

### SUMMARY

One or more aspects of example embodiments of the present invention relate to systems and methods for assessing cyber risks by analyzing each technology stack in an information technology (IT) system, and may include developing and/or assessing a cyber risk score by employing technical security standards corresponding to each technology stack. Employing technical security standards based on each technology stack may result in an objective and real-time assessment and management of cyber risks.

According to an example embodiment of the present invention, a system for cyber risk assessment includes: a processor; and a non-transitory computer-readable medium connected to the processor, wherein the non-transitory computer-readable medium stores computer-readable instructions that, when executed by the processor, cause the processor to: receive data corresponding to one or more technology stacks; access one or more security standards in a data store connected to the processor, at least one of the security standards corresponding to at least one of the technology stacks; and determine a cyber risk score based on the data and the at least one of the security standards.

In an example embodiment, the instructions may further cause the processor to: identify a technology multiplier corresponding to a probability of loss for each of the technology stacks; and identify a technology stack value for each of the technology stacks.

In an example embodiment, in the determining of the cyber risk score, the instructions may further cause the processor to: multiply a corresponding technology multiplier with a corresponding technology stack value for each of the technology stacks to obtain multiplication values for each of the technology stacks; and add the multiplication values together.

In an example embodiment, the instructions may further cause the processor to: identify a plurality of components for each of the technology stacks by utilizing functional point analysis; and categorize each of the components for each of the technology stacks into a plurality of severity categories.

In an example embodiment, the categories of each of the components may be determined from the security standards.

In an example embodiment, the instructions may further cause the processor to: determine a category mulitiplier for each one of the severity categories; and determine a number of the components in each of the severity categories.

In an example embodiment, in the identifying of the technology stack value for each of the technology stacks, the instructions may further cause the processor to: multiply a corresponding category multiplier with the number of components in a corresponding severity category for each of the severity categories; and sum the values obtained from the multiplication for each of the severity categories.

In an example embodiment, the cyber risk score may be calculated based on the following equation:

(TM A×Stack 1)+(TM B×Stack 2)+(TM C×Stack 3)++(TM n×Stack n),

wherein n is an integer, TM A through TM n are technology multipliers, and Stack 1 through Stack n are technology stack values for corresponding ones of the technology stacks.

In an example embodiment, each of the technology stack values may be calculated based on the following equation:

(FP CAT 1)×Number of CAT 1+(FP CAT 2)×Number of CAT 2+(FP CAT 3)×Number of CAT 3,

wherein CAT 1 through CAT 3 are severity categories, FP CAT 1 through FP CAT 2 are functional point multipliers for the severity categories, and Number of CAT 1 through Number of CAT 3 are the amount of risk for the severity categories.

According to an example embodiment of the present invention, a method for cyber risk assessment includes: receiving, by a processor, data corresponding to one or more technology stacks; accessing, by the processor, one or more security standards in a data store connected to the processor, at least one of the security standards corresponding to at least one of the technology stacks; and determining, by the processor, a cyber risk score based on the data and the at least one of the security standards.

In an example embodiment, the method may further include: identifying, by the processor, a technology multiplier corresponding to a probability of loss for each of the technology stacks; and identifying, by the processor, a technology stack value for each of the technology stacks.

In an example embodiment, the determining of the cyber risk score may further include: multiplying, by the processor a corresponding technology multiplier with a corresponding technology stack value for each of the technology stacks to obtain multiplication values for each of the technology stacks; and adding, by the processor, the multiplication values together.

In an example embodiment, the method may further include: identifying, by the processor, a plurality of components for each of the technology stacks by utilizing functional point analysis; and categorizing, by the processor, each of the components for each of the technology stacks into a plurality of severity categories.

In an example embodiment, the categories of each of the components may be determined from the security standards.

In an example embodiment, the method may further include: determining, by the processor, a category mulitiplier for each one of the severity categories; and determining, by the processor, a number of the components in each of the severity categories.

In an example embodiment, the identifying of the technology stack value for each of the technology stacks may include: multiplying, by the processor, a corresponding category multiplier with the number of components in a corresponding severity category for each of the severity categories; and summing, by the processor, the values obtained from the multiplication for each of the severity categories.

In an example embodiment, the cyber risk score may be calculated, by the processor, based on the following equation:

(TM A×Stack 1)+(TM B×Stack 2)+(TM C×Stack 3)++(TM n×Stack n),

wherein n is an integer, TM A through TM n are technology multipliers, and Stack 1 through Stack n are technology stack values for corresponding ones of the technology stacks.

In an example embodiment, each of the technology stack values may be calculated, by the processor, based on the following equation:

(FP CAT 1)×Number of CAT 1+(FP CAT 2)×Number of CAT 2+(FP CAT 3)×Number of CAT 3,

wherein CAT 1 through CAT 3 are severity categories, FP CAT 1 through FP CAT 2 are functional point multipliers for the severity categories, and Number of CAT 1 through Number of CAT 3 are the amount of risk for the severity categories.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below, and particularly pointed out in the claims filed with the application. Such combinations have particular advantages not specifically recited in the above summary. Other features and advantages of the present invention will be apparent from the accompanying drawings and from the detailed description that follows below.

### BRIEF DESCRIPTION OF THE DRAWINGS

The above and other aspects and features of the present invention will become more apparent to those skilled in the art from the following detailed description of the example embodiments with reference to the accompanying drawings, in which:

FIG. 1 illustrates a basic technology stack.

FIG. 2 is a system diagram of a cyber risk assessment and management system, according to an embodiment.

FIG. 3 is a flow diagram of a cyber risk assessment and management method, according to an embodiment.

FIG. 4 is a flow diagram of a cyber risk score generation method, according to an embodiment.

FIG. 5 is a flow diagram of a functional point analysis (FPA) cyber risk score equation generation method, according to an embodiment.

FIG. 6 is a flow diagram of a cyber risk updating method, according to an embodiment.

FIG. 7 is a flow diagram of a cyber risk score updating method employed in response to a security crisis, according to an embodiment.

FIGS. 8A-8D are block diagrams of computing devices according to one or more example embodiments.

FIG. 8E is a block diagram of a network environment including several computing devices according to an example embodiment.

### DETAILED DESCRIPTION

Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Aspects of the current disclosure are related to cyber insurance policies and an automated, fact-based method for risk assessment and generation of cyber risk scores that are used in cyber insurance policies underwriting.

Organizations that manage risk using cyber insurance have increasing economic incentives to reduce exposure in tangible ways, for example by following best practices specifications of the techniques and equipment to be used for security protection. However, unclear or subjective pricing policies may lead organizations to avoid using cyber insurance, creating difficulties for themselves by increasing cyber risks that may lead to financial losses, as well as decreasing chances for cyber insurance companies to commercialize their products.

Methods of performing cyber risk assessments include audits by independent information technology (IT) security consultants on a case-by case basis, depending on the risks to be covered and the policy limits sought. To this end, a cyber insurance underwriter may first ask prospective clients to complete an information security assessment that covers all IT equipment as well as company IT policies and practices. Then a customer validation may take place through IT audits. Basic forms of IT equipment may be what is herein referred to as technology stacks, which are a set of software and hardware that provides the infrastructure for a computer or computer-related equipment.

According to an embodiment, a cyber risk assessment and management system and method may involve a cyber insurance agent in charge of selling a cyber insurance policy to a customer and assisting the customer to register with a clearing house. The customer, before purchasing this coverage, may complete a clearing house web-based questionnaire that provides information to the clearing house for identifying technology stacks and corresponding technical security standards registered in a technical security standard database which is kept continuously updated. These technical security standards are employed by the clearing house to generate a cyber risk score and to capture exposure based on the different cyber hazard classes. A clearing house may additionally generate an audit check list based on the technical security standards, which may be used by an auditor for validating customer data. The auditor may also identify areas for hardening exposures, which increases protection of the different technology stacks.

A pre-event management system may be responsible for generating an assessment of possible security breaches, assisting customers in hardening exposures, and up-selling any additional protection to the customer. A crisis response management system, on the other hand, may be responsible for assigning a crisis response manager as a point of contact for the customer in case of security breaches. When a security breach occurs, the customer may inform the crisis response manager to assess any data loss, identify actions to be taken, contact industry experts for assistance in response, send out privacy notifications as dictated by law, and establish credit monitoring and call center support.

According to an embodiment, a cyber risk score generation method, for which a clearing house may be responsible, includes identifying technology stacks that are used for determining technical security standards. The method may further include developing and employing a cyber risk score generation equation that takes into account these technical security standards. A cyber risk score may then be generated.

According to an embodiment, any suitable technical security standards may be employed, such as, for example, Security Technical Implementation Guides (STIGs). STIGs are configuration standards for Department of Defense Information Assurance (DOD IA) and IA-enabled devices and systems, which are provided by the Defense Information Systems Agency (DISA). STIGs provide suitable technical standards for diminishing cyber risks of each technology stack, and may provide valuable information for generation of cyber risk scores. Cyber Security Technical Implementation Guides (CSTIGs) are modifications of the STIGs to better address non-DOD IA areas. Additionally, CSTIGs may incorporate other Information Assurance policies that are not directly related to the STIGs

According to an embodiment, a suitable cyber risk score generation method employs functional point analysis (FPA) and information from CSTIGs. An FPA cyber risk score generation equation may be as follows:

(TM A×Stack 1)+(TM B×Stack 2)+(TM C×Stack 3)++(TM n×Stack n)=Cyber Risk Score,

where n is an integer greater than 1, TM A through TM n are technology multipliers corresponding to probability of data loss, and Stack 1 through Stack n are particular stack values.

The cyber risk score generation method may include: identify technology stacks; identify corresponding CSTIGs or technology best practices; identifying a technology multiplier (TM), or probability of data loss, for each of the technology stacks; identify a technology stack value (Stack) for each of the technology stacks; and plugin in the values into the cyber risk score generation equation for a final generation of a cyber risk score. The technology multiplier TM may be obtained from historical data, for example. Stack values may be obtained from the following equation:

(FP CAT 1)×Number of CAT 1+(FP CAT 2)×Number of CAT 2+(FP CAT 3)*Number of CAT 3=Stack,

where FP CAT is a Functional Point multiplier for each CAT, and Number of CAT is the amount of risks under each CAT.

Each FP CAT multiplier is a value that may depend on the severity of CAT. Number of CATs may be found in the list of CSTIGs.

According to an embodiment, a cyber risk score updating method may take place whenever new updates are available, which may prompt customers to implement these updates and update clearing house documentation. Clearing house may then automatically update the cyber risk score based on this information.

According to an embodiment, a cyber risk score updating method in response to a security breach may follow the occurrence of a security breach. A customer may then inform a crisis response manager to begin the coordination of a crisis response. After the security breach has been cleared, a customer may want to update clearing house documentation, upon which clearing house may update the cyber risk score.

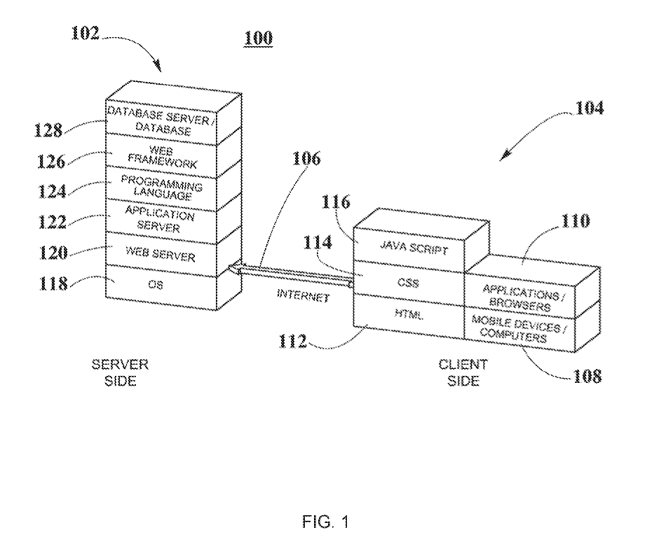

FIG. 1 illustrates a basic networked technology stack 100, which may be utilized for development and utilization of a web application. However, the technology stack 100 shown in FIG. 1 is only an example, and thus, may include more or fewer elements than those shown in FIG. 1.

Technology stack 100 is a client-server networked architecture whereby some resources are located on one or more computers on a server side 102, and are available to one or more other computers on a client side 104. Client side 104 represents operations that are performed by a client, and may send a request following Hypertext Transfer Protocol (HTTP), for example, whereas server side 102 represents operations that are performed by a server for sending a response to the request, and may also follow HTTP, for example. Client side 104 and server side 102 are connected to each other through internet 106.

For clarity, different technology stacks whether client or server side, are all contemplated within this architecture.

In FIG. 1, a hardware layer 108 on the client side 104 may include, for example, mobile devices and computers for enabling access to an interface layer 110, which may include applications and browsers, among other elements. For example, some layers for running elements in the interface layer 110 on the client side 104 may include a structure layer 112, a style layer 114, and a behavior layer 116.

Structure layer 112 defines the data structure of content from the client side 104, for example, by using HyperText Markup Language (HTML), which is the standard markup language for creating web pages and web applications. Style layer 114, which controls aesthetics including, for example, color, text fonts and styles, layouts, and other visual aspects, may utilize Cascading Style Sheets (CSS), for example, which is a style sheet language used for describing the presentation of a document written in a markup language. Behavior layer 116, which deals with the programmed interaction on the client side 104, may use any suitable programming language, such as JavaScript.

Server side 102 is responsible for providing services requested by the client side 104. Users generally do not directly engage with the server side 102, because all information is generally passed directly through the client side 104. Server side 102 may include an operating system (OS) 118 that is used to manage requests from, and to provide responses to, the client side 104. A request handled by OS 118 is passed to a web server 120, which includes web servers (e.g, using HTTP) to serve requested files or information to client side 104. Web server 120 may then pass on data to an application server 122 running server side programs or components of programs that are used to provide services requested by the client side 104. A programming language 124 is used to write these programs or components of programs. A web framework 126 written in the programming language 124 may support development of web applications. The server side 102 may also include a database server/database 128 that is responsible for managing data used to run a web application.

The overall system may be technology agnostic. For example, OS 118 may include Disk Operating System (DOS), Microsoft Windows, MacOS, Unix-Linux, and/or the like. Web servers 120 may include Apache, Microsoft Internet Information System (IIS), Nginx, Google Web Server (GWS), and/or the like. Common programming languages may include Java, MS. Net languages, PHP, Ruby, Python, and/or the like. Common database servers may include Oracle, MySQL, Microsoft SQL Server, PostgreSQL, IBM DB2, and/or the like.

Technology stacks 100 may be susceptible to several cyber risks (or cyber attacks). Therefore, several lists of technical security standards have been developed in order for companies to properly manage and diminish or reduce these cyber risks. Cyber risks that may affect technology stacks 100 may include botnets, distributed denial-of-service (DDoS) attacks, hacking, malware, pharming, phishing, ransomware, spam, spoofing, spyware, trojan horses, viruses, Wi-Fi eavesdropping, worms, and/or the like.

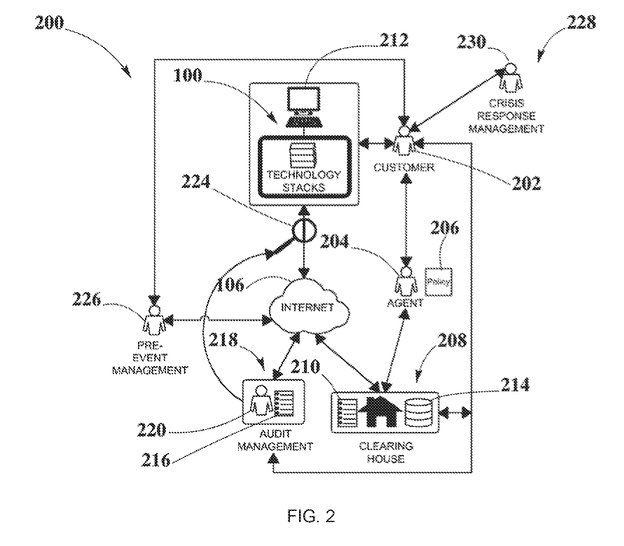

FIG. 2 is a system diagram of a cyber risk assessment and management system 200, according to an embodiment. Various elements and actors in a cyber risk assessment and management system 200 are utilized together in order to quantify and manage cyber risks for a customer 202, and to determine an objective and clear underwriting as well as a premium price point for subsequent cyber risk management.

In FIG. 2, a cyber insurance agent 204 is in charge of selling a cyber insurance policy 206 to the customer 202, and may act as an intermediary between the customer 202 and a clearing house 208.

The customer 202 may sign up for a cyber risk assessment offered by the cyber insurance agent 204, and the customer 202 may complete a clearing house web questionnaire 210 through a suitable computer interface 212 that is connected to internet 106, in order to determine applicable technology stacks 100 for the customer 202. Clearing house 208 may include a processor, and memory (e.g., a non-transitory computer-readable medium) connected to the processor and storing instructions thereon to control the processor. The processor of the clearing house 207 is further connected to a suitable technical security standards database 214, which may include technical security standards for each corresponding technology stack 100, and which may be kept updated (e.g., continuously updated). These technical security standards may be employed for the generation of a cyber risk score and hazard classes. Generation of the cyber risk score and hazard classes are used for creating a clear underwriting and premium price point for the customer 202. When the customer 202 agrees to purchase a complete cyber insurance policy 206 (e.g., with the proposed price point resulting from the cyber risk assessment), clearing house 208 may generate an audit checklist 216 based on the technical security standards for the corresponding technology stacks 100, and the audit checklist 216 may be used for customer data validation.

However, the present invention is not limited thereto. For example, in some embodiments, the customer 202 may register (e.g., directly register) with the clearing house 208 without the cyber insurance agent 204 acting as the intermediary.

After clearing house 208 has determined an audit checklist 216, an audit management 218 performs an audit in order to validate the customer data. For example, an auditor 220 may utilize a network scanner 224, may interview the customer 202, and may sometimes conduct site visits, as desired or required for appropriate customer data validation. An audit may additionally be performed in order to identify areas to “harden” systems exposed to cyber risks for customer 202. As used herein, “harden” or “hardening” may refer to actions that may result in increasing/increased levels of protection against cyber risks for the customer 202.

Further in FIG. 2, pre-event management 226 is responsible for generating any advance work for determining possible security breaches, assisting the customer 202 for hardening exposures, and up-selling any additional protection to the customers 202.

Crisis response management 228 is in charge of assigning a crisis response manager 230 as a point of contact of customer 202. Whenever there is a security breach, or crisis, the crisis response manager 230 may be informed by the customer 202, and may subsequently assess data loss, identify actions to be taken, contact industry experts for assistance in response, send out privacy notifications as dictated by law, etc., and may establish credit monitoring and call center support (CSID).

Data sharing and communication between the different actors and elements of the cyber risk assessment and management system 200 may be performed through connection to a suitable network such as internet 106.

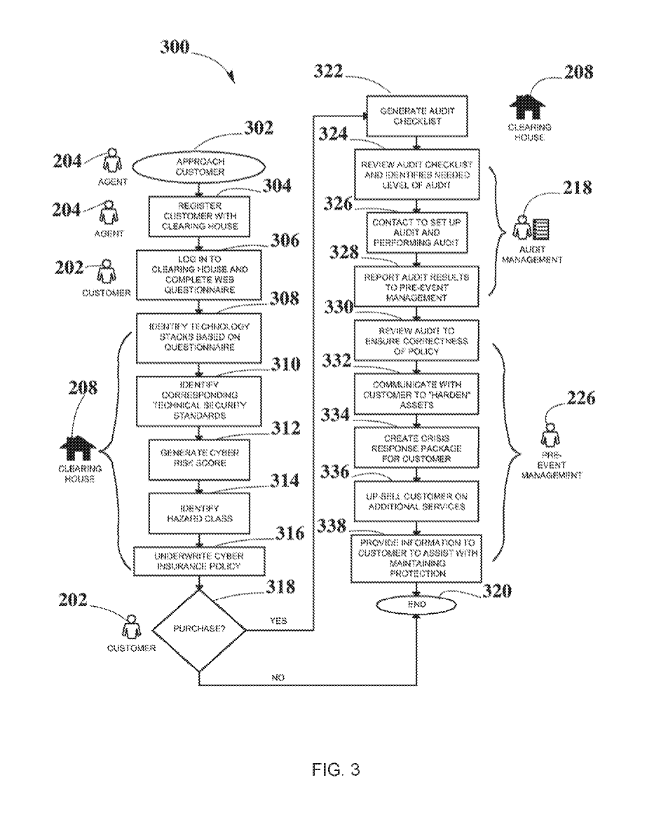

FIG. 3 illustrates a cyber risk assessment and management method 300, according to an embodiment. Cyber risk assessment and management method 300 may start when a cyber insurance agent 204 approaches a customer 202 with a cyber risk assessment proposal at block 302. If the customer 202 agrees, cyber insurance agent 204 may register the customer 202 with a clearing house 208 at block 304. Customer 202 is then prompted to log in to the clearing house 208 to complete a web questionnaire 210 at block 306.

According to an embodiment, the clearing house web questionnaire 210 follows a logic linked to the different components in the technology stacks 100 employed by customer 202. In other words, the clearing house web questionnaire 210 may differ from other insurance questionnaires by increasing the precision and convenience of extracting potential cyber risks information, for example, by requesting only information relevant to the technology stacks 100 owned by the customer 202. For example, the clearing house web questionnaire 210 may first determine components on client side 104 of technology stack 100, by prompting the customer 202 to specify each of the layers of the technology stack 100, and then may proceed in a similar fashion on the server side 102.

Logging in to the clearing house 208 and completing the web questionnaire 210 at block 306 provides the clearing house 208 with information that identifies the technology stacks 100 at block 308, which is used for identifying corresponding technical security standards at block 310. Then, the information indentifying the technology stacks 100 and the corresponding technical security standards are used by the clearing house 208 for generating a cyber risk score at block 312, and identifying (e.g., subsequently identifying) cyber hazard classes at block 314. Employing information from the cyber risk score and the cyber hazard classes, clearing house 208 may underwrite a cyber insurance policy 206 at block 316. The customer 202 may then decide whether or not to purchase the cyber insurance policy 206 at block 318. If the customer does not decide to purchase the cyber insurance policy 206, the process may end at block 320. However, if the customer 202 purchases the cyber insurance policy 206, the clearing house 208 may proceed by generating an audit checklist at block 322 based on the information from the clearing house web questionnaire 210 that may be used for customer data validation.

Subsequently, an auditor 220 from audit management 218 reviews the audit checklist, and identifies a needed or desired level of audit at block 324, after which the auditor 220 contacts the customer 202 to set up and perform the audit at block 326 for customer data validation. Feedback from the audit may be further utilized for updating the cyber risk scores and hazard classes, if desired or necessary.

Audit management 218 then reports audit results to pre-event management 226 at block 328, which reviews the audit to ensure correctness of the cyber insurance policy 206 at block 330. Other functions that may be performed by pre-event management 226 that are not necessarily in order stated herein may include, for example, communicating with the customer to harden assets of the technology stack at block 332, creating a crisis response package for the customers at block 334, up-selling the customer on additional services at block 336, and providing information to the customer to assist with maintaining protection at block 338, which may be done through newsletters or direct contact. Communication between the customer 202 and pre-event management 226 may then continue as desired in order to maintain updates (e.g., constant updates) of cyber risk assessment and cyber risk scores.

Hardening of assets by pre-event management 226 may be of particular importance when technology stacks 100 function with computer patches, which are pieces of software designed to update, make repairs, or improve computer programs or associated supporting data.

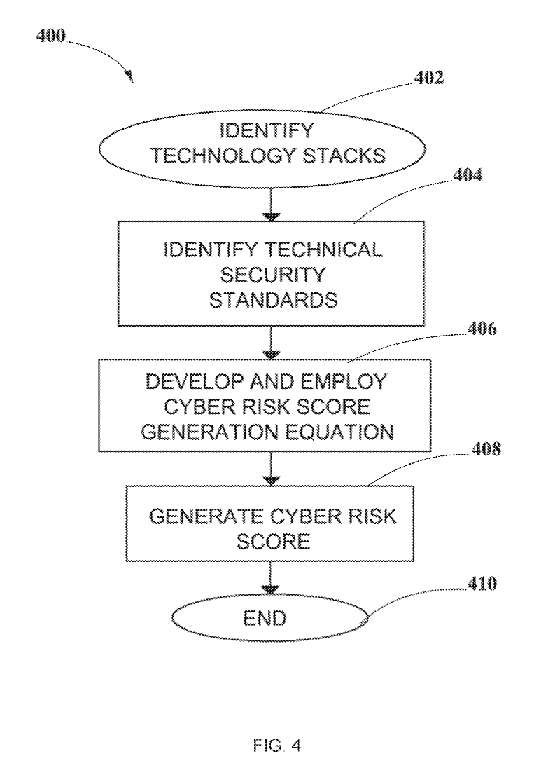

FIG. 4 is a flow diagram of a cyber risk score generation method 400, according to an embodiment. Generally, cyber risk score generation method 400 is based upon an adequate identification of the technology stacks at block 402, which may be obtained from clearing house web questionnaire 210 that is filled out by customer 202.

Once the technology stacks 100 have been identified, cyber risk score generation method 400 may identify technical security standards at block 404, for which any suitable technical security standard developed for the purpose of preventing or reducing cyber risks may be applicable.

For example, some suitable technical security standards may include ISO 27001, ISO 27002, British Standard 7799 Part 3, Control Objectives for Information and Related Technology (COBIT), Common Criteria (also known as ISO/IEC 15408), ITIL (or ISO/IEC 20000 series), National Information Security Technology Standard Specification, SANS Security Policy Resource, and/or the like.

As a non-limiting example embodiment, the technical security standards may include the Security Technical Implementation Guides (STIGs), which are configuration standards for Department of Defense Information Assurance (DOD IA) and IA-enabled devices and systems, and which are provided by the Defense Information Systems Agency (DISA). STIGs contain technical guidance to “lock down” information systems and software that may otherwise be vulnerable to malicious computer attacks. A comprehensible list of STIGs may be found in the Unified Compliance Framework website at https://www.stigviewer.com/.

In some existing systems, cyber risk scores may be generated by taking into account information from external surveillance of a company's security practices, publicly available intelligence, and/or an evaluation of the company's proprietary information. For example, the external surveillance of a company's security practices may include vulnerabilities to active gateways, encryption, multi-factor authentication, patching frequency, file sharing practices, leaked credentials found on the web, spam propagation, open ports, and/or the like. The publicly available intelligence may include, for example, open source malware intelligence, subscription threat intelligence data feeds, hacker/dark web chatter, and/or the like. The proprietary information may include, for example, historical data collected to establish behavior patterns, proprietary algorithms, and/or the like.

However, in these existing systems, cyber risk score generation does not employ information extraction based on technical security standards. Accordingly, referring again to FIG. 4, after identifying the technical security standards at block 404, the clearing house 208 may develop and/or employ a cyber risk score generation equation at block 406, that utilizes information from the technical security standards corresponding to each technology stack 100. Afterwards, the clearing house 208 may generate a cyber risk score at block 408 based on the cyber risk score generation equation for use in the cyber insurance underwriting, and the cyber risk score generation method ends at block 410.

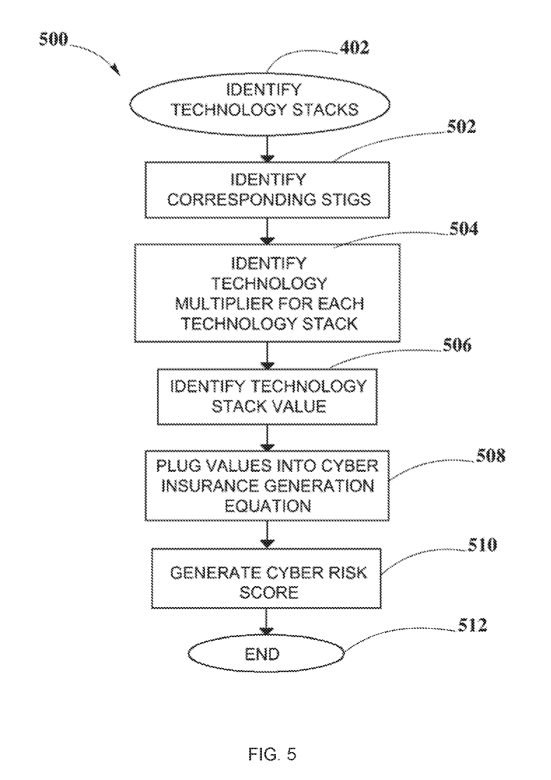

FIG. 5 is a flow diagram of a functional point analysis (FPA) cyber risk score equation generation method 500, according to an embodiment. The method 500 begins by identifying the technology stacks at block 502. At block 504, the technical security standards (e.g., CSTIGs) are identified. Accordingly, a sample FPA cyber risk score equation may be generated as the following Equation 1.

(TM A×Stack 1)+(TM B×Stack 2)+(TM C×Stack 3)++(TM n×Stack n)=Cyber Risk Score, Equation 1:

where n is an integer, TM A through TM n are technology multipliers, and Stack 1 through Stack n are technology stacks.

Therefore, after identifying the corresponding technical security standards (e.g., CSTIGs) at block 502, the method 500 may identify a technology multiplier for each of the technology stacks at block 504. The technology multiplier may be referred to herein as a probability of loss depending on each technology stack 100, and may be obtained from historical data, for example. For example, the technology multiplier TM for laptops is 20%, while the technology multiplier TM for servers is 5%.

After determining the technology multiplier TM for each technology stack 100, the clearing house 208 may identify a technology stack value for each of the technology stacks at block 506. The technology stack value may be determined by using FPA for each severity category CAT. FPA is a structured technique of classifying components of a system, that is used to break systems into smaller components for better analysis and understanding. CATs may be determined from the aforementioned list of CSTIGs. The technology stack value may be determined via the following equation 2.

(FP CAT 1)×Number of CAT 1+(FP CAT 2)×Number of CAT 2+(FP CAT 3)×Number of CAT 3=Stack, Equation 2:

where FP CAT is a functional point multiplier for each CAT and Number of CAT is the amount of risk for each CAT.

Each FP CAT multiplier may depend on the severity of the CAT. For example, CAT1 represents critical risks, so it may be assigned an FP CAT1 of 2, for example. CAT2 represents medium level risks, and thus, may be assigned an FP CAT2 of 0.5, for example. CAT3 represents low level risks, and thus, may be assigned an FP CAT3 of 0.25, for example. Taking Apache for Windows 2.0 as a non-limiting example, there are 5 CAT1, 45 CAT2, and 5 CAT3. Thus, in this example, plugging in the values into Equation 2 above results in: ((FP CAT 1)×5)+((FP CAT 2)×45))+((FP CAT 3)×5))=Stack. Further, plugging in the above example values for FP CAT 1=2, FP CAT 2=0.5, and FP CAT 3=0.25, results in: (2×5)+(0.5×45)+(0.25×5)=10+22.5+1.25=33.75.

After identifying the technology stack value at block 506, the clearing house 208 may plugin the resulting values into Equation 1. Thus, referring back to the Apache example above, and assuming a 5% technology multiplier TM for servers, the result may be as follows: (0.05)×(33.75)+(TM B)×(Stack 2)+(TM C)×(Stack 3)++(TM n)×(Stack n)=Cyber Risk Score.

The same or substantially the same process may be performed for the rest of the technology stacks 100 to plugin corresponding values into Equation 1 at block 508 to generate the cyber risk score at block 510, and ending the process at block 512.

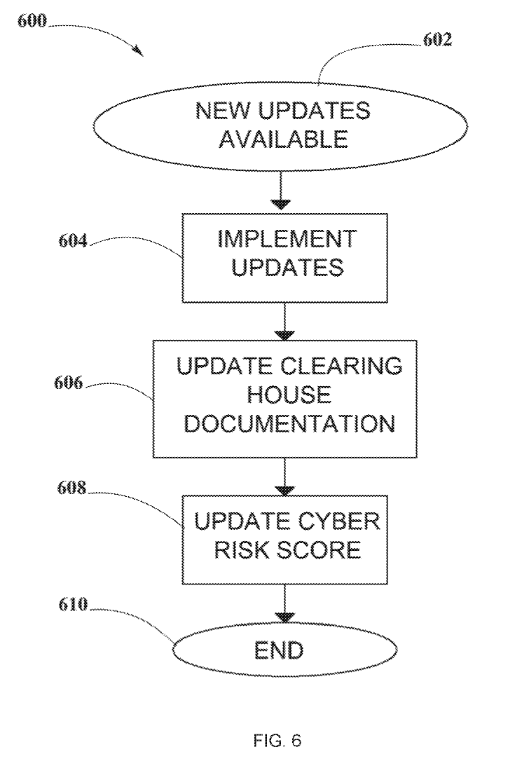

FIG. 6 is a flow diagram of a cyber risk score updating method 600, according to an embodiment. The method 600 may start when new updates are available at block 602. Updates may refer herein to new cyber patches, creation or renewal of security policies, addition or removal of technology stacks 100, and/or the like. If there are updates available in the system, cyber risk score updating method 600 may prompt the customers to implement the updates at block 604, and the clearing house documentation may be updated at block 606. Subsequently, clearing house 208 may use this updated information to automatically update cyber risk score at block 608 (e.g., using the same or substantially the same method 500 as described with reference to FIG. 5) and the process may end at block 610.

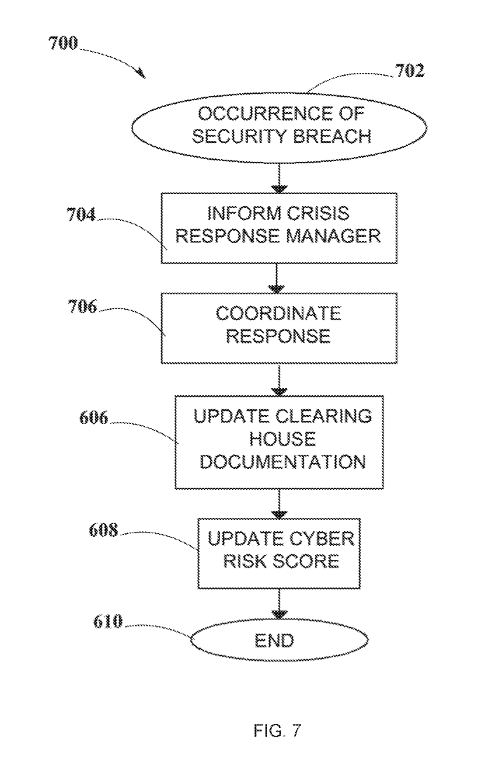

FIG. 7 is a flow diagram of a cyber risk score updating method 700 in response to a security breach, according to an embodiment. The method 700 may begin with the occurrence of a security breach at block 702. Subsequently, the customer 202 informs the crisis response manager at block 704 to coordinate a response at block 706. After the security breach has been cleared, the customer 202 may desire or need to update the clearing house documentation at block 606. After the clearing house documentation is updated at block 606, the clearing house 208 may update the cyber risk score at block 608, and the process may end at block 610.

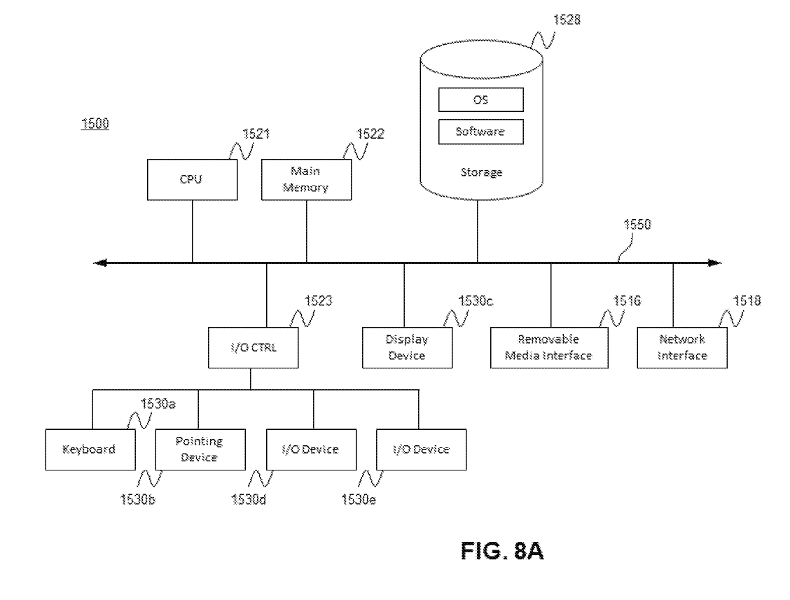

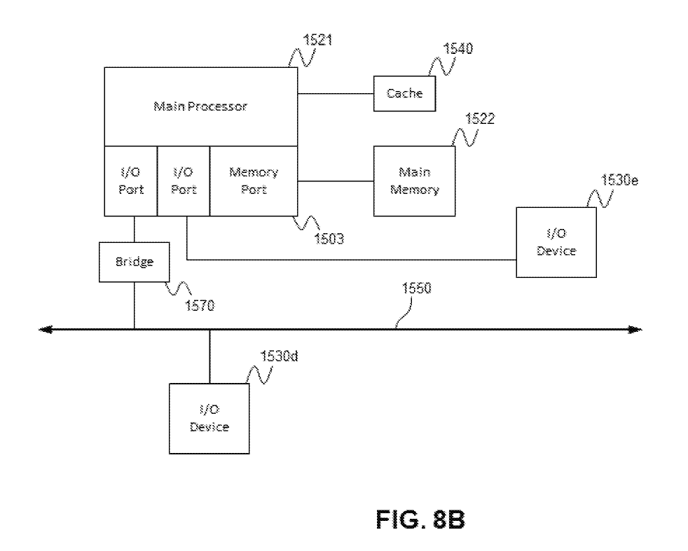

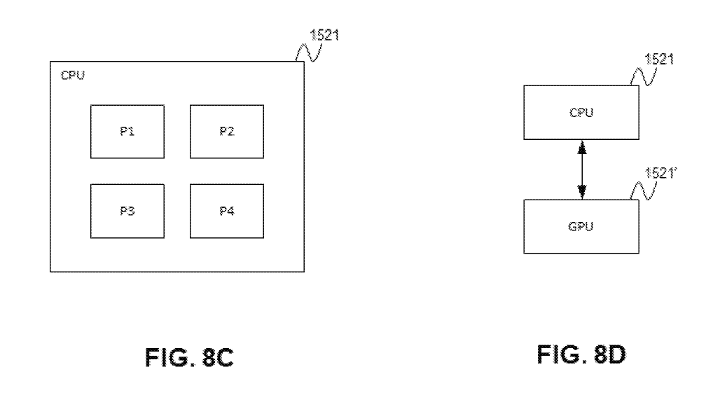

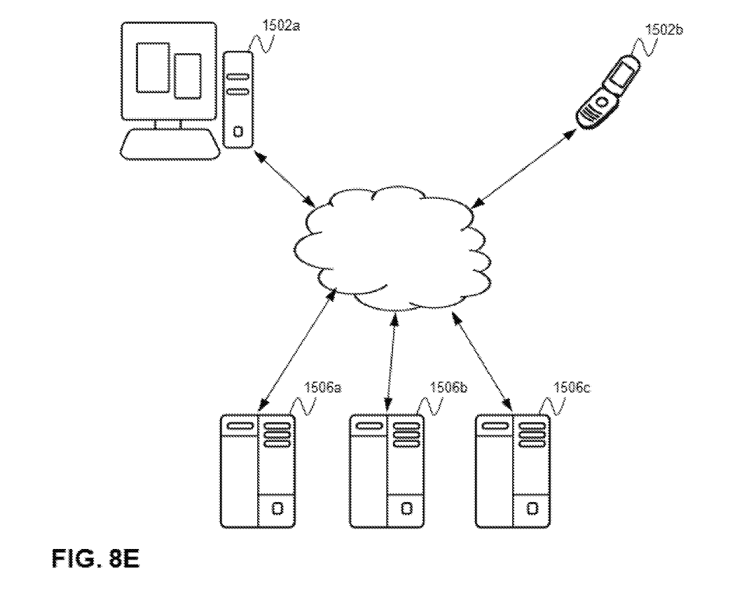

FIGS. 8A to 8D are block diagrams of computing devices according to example embodiments of the present invention. FIG. 8E is a block diagram of a network environment including several computing devices according to an example embodiment of the present invention.

In one embodiment, each of the various servers, controllers, switches, gateways, engines, and/or modules (collectively referred to as servers) in the afore-described figures are implemented via hardware or firmware (e.g. ASIC) as will be appreciated by a person of skill in the art.

In one embodiment, each of the various servers, controllers, engines, and/or modules (collectively referred to as servers) in the afore-described figures may be a process or thread, running on one or more processors, in one or more computing devices 1500 (e.g., FIG. 8A, FIG. 8B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 8A and FIG. 8B depict block diagrams of a computing device 1500 as may be employed in exemplary embodiments of the present invention. Each computing device 1500 includes a central processing unit 1521 and a main memory unit 1522. As shown in FIG. 8A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 8B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 8A, the central processing unit 1521 communicates with the main memory 1522 via a system bus 1550. As shown in FIG. 8B, the central processing unit 1521 may also communicate directly with the main memory 1522 via a memory port 1503.

FIG. 8B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 8A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 8B depicts an embodiment of a computer 1500 in which the central processing unit 1521 communicates directly with I/O device 1530e. FIG. 8B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 8A, may control the I/O devices. The I/O controller may control one or more I/O devices such as a keyboard 1530a and a pointing device 1530b, e.g., a mouse or optical pen.

Referring again to FIG. 8A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 8A and FIG. 8B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 8C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 8D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 8E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 8E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 8E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

According to an embodiment, updating of the cyber risk score at block 608 may be performed by employing the (FPA) cyber risk score equation generation method 500 as described above with reference to FIG. 5, with the values obtained from new CSTIGs.

According to other embodiments, updating of the cyber risk score at block 608 may be performed by employing any other suitable cyber risk score generation equation that utilizes technical security standards based on updates for each technology stack 100.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A system for cyber risk assessment comprising:
a processor; and
a non-transitory computer-readable medium coupled to the processor, wherein the non-transitory computer-readable medium stores computer-readable instructions that, when executed by the processor, cause the processor to:
receive data corresponding to one or more technology stacks;
access one or more security standards in a data store coupled to the processor, at least one of the security standards corresponding to at least one of the technology stacks; and
determine a cyber risk score based on the data and the at least one of the security standards.

2. The system of claim 1, wherein the instructions further cause the processor to:
identify a technology multiplier corresponding to a probability of loss for each of the technology stacks; and
identify a technology stack value for each of the technology stacks.

3. The system of claim 2, wherein, in the determining of the cyber risk score, the instructions further cause the processor to:
multiply a corresponding technology multiplier with a corresponding technology stack value for each of the technology stacks to obtain multiplication values for each of the technology stacks; and
add the multiplication values together.

4. The system of claim 2, wherein the instructions further cause the processor to:
identify a plurality of components for each of the technology stacks by utilizing functional point analysis; and
categorize each of the components for each of the technology stacks into a plurality of severity categories.

5. The system of claim 4, wherein the categories of each of the components are determined from the security standards.

6. The system of claim 4, wherein the instructions further cause the processor to:
determine a category multiplier for each one of the severity categories; and
determine a number of the components in each of the severity categories.

7. The system of claim 6, wherein, in the identifying of the technology stack value for each of the technology stacks, the instructions further cause the processor to:
multiply a corresponding category multiplier with the number of components in a corresponding severity category for each of the severity categories; and
sum the values obtained from the multiplication for each of the severity categories.

8. The system of claim 1, wherein the cyber risk score is calculated based on the following equation:
(TM A×Stack 1)+(TM B×Stack 2)+(TM C×Stack 3)++(TM n×Stack n),
wherein n is an integer, TM A through TM n are technology multipliers, and Stack 1 through Stack n are technology stack values for corresponding ones of the technology stacks.

9. The system of claim 8, wherein each of the technology stack values is calculated based on the following equation:
(FP CAT 1)×Number of CAT 1+(FP CAT 2)×Number of CAT 2+(FP CAT 3)×Number of CAT 3,
wherein CAT 1 through CAT 3 are severity categories, FP CAT 1 through FP CAT 2 are functional point multipliers for the severity categories, and Number of CAT 1 through Number of CAT 3 are the amount of risk for the severity categories.

10. A method for cyber risk assessment, the method comprising:
receiving, by a processor, data corresponding to one or more technology stacks;
accessing, by the processor, one or more security standards in a data store coupled to the processor, at least one of the security standards corresponding to at least one of the technology stacks; and
determining, by the processor, a cyber risk score based on the data and the at least one of the security standards.

11. The method of claim 10, further comprising:
identifying, by the processor, a technology multiplier corresponding to a probability of loss for each of the technology stacks; and
identifying, by the processor, a technology stack value for each of the technology stacks.

12. The method of claim 11, wherein the determining of the cyber risk score further comprises:
multiplying, by the processor a corresponding technology multiplier with a corresponding technology stack value for each of the technology stacks to obtain multiplication values for each of the technology stacks; and
adding, by the processor, the multiplication values together.

13. The method of claim 11, further comprising:
identifying, by the processor, a plurality of components for each of the technology stacks by utilizing functional point analysis; and
categorizing, by the processor, each of the components for each of the technology stacks into a plurality of severity categories.

14. The method of claim 13, wherein the categories of each of the components are determined from the security standards.

15. The method of claim 13, further comprising:
determining, by the processor, a category multiplier for each one of the severity categories; and
determining, by the processor, a number of the components in each of the severity categories.

16. The method of claim 15, wherein the identifying of the technology stack value for each of the technology stacks comprises:
multiplying, by the processor, a corresponding category multiplier with the number of components in a corresponding severity category for each of the severity categories; and
summing, by the processor, the values obtained from the multiplication for each of the severity categories.

17. The method of claim 10, wherein the cyber risk score is calculated, by the processor, based on the following equation:
(TM A×Stack 1)+(TM B×Stack 2)+(TM C×Stack 3)++(TM n×Stack n),
wherein n is an integer, TM A through TM n are technology multipliers, and Stack 1 through Stack n are technology stack values for corresponding ones of the technology stacks.

18. The method of claim 17, wherein each of the technology stack values is calculated, by the processor, based on the following equation:
(FP CAT 1)×Number of CAT 1+(FP CAT 2)×Number of CAT 2+(FP CAT 3)×Number of CAT 3,
wherein CAT 1 through CAT 3 are severity categories, FP CAT 1 through FP CAT 2 are functional point multipliers for the severity categories, and Number of CAT 1 through Number of CAT 3 are the amount of risk for the severity categories.

19. A system for cyber risk assessment comprising:
a processor; and
a non-transitory computer-readable medium coupled to the processor, wherein the non-transitory computer-readable medium stores computer-readable instructions that, when executed by the processor, cause the processor to:
receive data corresponding to one or more technology stacks;
access one or more security standards in a data store coupled to the processor, at least one of the security standards corresponding to at least one of the technology stacks;
identify a technology multiplier corresponding to a probability of loss for each of the technology stacks;
identify a technology stack value for each of the technology stacks;
multiply a corresponding technology multiplier with a corresponding technology stack value for each of the technology stacks to obtain multiplication values for each of the technology stacks; and
add the multiplication values together to determine a cyber risk score.

20. The system of claim 19, wherein the instructions further cause the processor to:
identify a plurality of components for each of the technology stacks by utilizing functional point analysis;
categorize each of the components for each of the technology stacks into a plurality of severity categories;
determine a category multiplier for each one of the severity categories;
determine a number of the components in each of the severity categories;
multiply a corresponding category multiplier with the number of components in a corresponding severity category for each of the severity categories; and
sum the values obtained from the multiplication for each of the severity categories to generate a corresponding technology stack value for a corresponding one of the technology stacks.
